(19) United States
(12) Patent Application Publication
(10) Pub. No.: US 2024/0426441 A1
(43) Pub. Date: Dec. 26, 2024

(54) INTERNAL LIGHTING MODULE

(71) Applicant: SIGNIFY HOLDING B.V., EINDHOVEN (NL)

(72) Inventors: STEVEN WALTER PYSHOS, BOCA RATON, FL (US); JASON QUENTIN PAULSEL, PEACHTREE CITY, GA (US)

(21) Appl. No.: 18/704,015

(22) PCT Filed: Oct. 24, 2022
(86) PCT No.: PCT/EP2022/079578

§ 371 Date: Apr. 23, 2024

Related U.S. Application Data
(60) Provisional application No. 63/272,832, filed on Oct. 28, 2021.

(30) Foreign Application Priority Data
Nov. 8, 2021 (EP) 21206922.3

(51) Int. Cl. F21S 8/02; F21S 9/02; F21V 15/01; F21V 23/04; F21Y 113/10

(52) U.S. Cl. CPC F21S 8/026; F21S 9/024; F21V 15/01; F21V 23/045; F21Y 2113/10

(57) ABSTRACT

An internal lighting module for a luminaire, where the internal lighting module includes a housing having a profile shape that matches that of a top end of a trim of the luminaire and a bottom end of an enclosure of the luminaire. The internal lighting module can also include a light source configured to emit light away from an inner perimeter of the housing. The internal lighting module can further include an electrical connection interface electrically coupled to the light source, where the electrical connection interface is configured to couple to a power source. The housing can be configured to be positioned between the trim and an enclosure of the luminaire.

### TECHNICAL FIELD

The present disclosure relates generally to luminaires, and more particularly to systems, methods, and devices for internal lighting modules for luminaires, such as recessed or downlight luminaires.

### BACKGROUND

In a number of applications (e.g., commercial applications), code requires an illumination of path of egress during a power outage. One common method is to provide emergency lighting that consists of a wall or ceiling mount emergency light fixture. A remote test switch and indicator light is required to confirm that the emergency lighting is functioning properly. A number of standards, regulations, and/or other requirements (e.g., codes) apply to emergency egress lighting and the testing and maintenance thereof.

### SUMMARY

In general, in one aspect, the disclosure relates to an internal lighting module for a luminaire. The internal lighting module can include a housing having a bottom view profile shape that substantially matches that of a top end of a trim of the luminaire and a top view profile shape that substantially matches that of a bottom end of an enclosure of the luminaire. The internal lighting module can also include a light source configured to emit light away from an inner perimeter of the housing. The internal lighting module can further include an electrical connection interface electrically coupled to the light source, where the electrical connection interface is configured to couple to a power source. The housing can be configured to be positioned between the trim and an enclosure of the luminaire.

In another aspect, the disclosure relates to a luminaire that includes a trim comprising a trim body, wherein the trim body has a profile shape at its top end. The luminaire can also include an enclosure having substantially the profile shape at its bottom end. The luminaire can further include a first light source and a first power source that provides power to the first light source. The luminaire can also include a second power source that provides emergency power when the first power source is unavailable. The luminaire can further include an internal lighting module disposed between the top end of the trim and the bottom end of the enclosure. The internal lighting module can include a housing having substantially the profile shape at its top and bottom surfaces. The internal lighting module can also include a second light source configured to emit light away from an inner perimeter of the housing. The internal lighting module can further include an electrical connection interface electrically coupled to the second light source and at least one of the first power source and the second power source. The luminaire can further include a plurality of securing member assemblies that engage the top end of the trim and the bottom end of the enclosure to retain the internal lighting module therebetween.

These and other aspects, objects, features, and embodiments will be apparent from the following description and the appended claims.

### BRIEF DESCRIPTION OF THE DRAWINGS

The drawings illustrate only example embodiments and are therefore not to be considered limiting in scope, as the example embodiments may admit to other equally effective embodiments. The elements and features shown in the drawings are not necessarily to scale, emphasis instead being placed upon clearly illustrating the principles of the example embodiments. Additionally, certain dimensions or positions may be exaggerated to help visually convey such principles. In the drawings, reference numerals designate like or corresponding, but not necessarily identical, elements.

FIGS. 1A through 1D show various views of part of a lighting system that includes a recessed luminaire according to certain example embodiments.

FIGS. 2A through 2D show various views of the internal lighting module of the recessed luminaire of FIGS. 1A through 1D.

FIGS. 3A and 3B show various views of another internal lighting module according to certain example embodiments.

FIGS. 4A through 4C show a subassembly that includes a luminaire coupling feature of FIGS. 1A through 1D.

FIG. 5 shows a diagram of a system that includes a recessed luminaire according to certain example embodiments.

FIG. 6 shows a system diagram of the controller of the internal lighting module of the system of FIG. 5A.

FIG. 7 shows a computing device in accordance with certain example embodiments.

### DETAILED DESCRIPTION

In general, example embodiments provide systems, methods, and devices for internal lighting modules. Example embodiments can provide a number of benefits. Such benefits can include, but are not limited to, fewer parts to keep in inventory, ease of use in testing and operation, flexibility of use, added aesthetic value, avoidance of added costs (e.g., fewer components to install, maintain, and repair), modularity, and user control. Example embodiments can be used with new luminaires or retrofit with existing luminaires. Luminaires can include lamps, light fixtures, lighting devices, and/or lighting systems. While example embodiments described herein are directed to recessed luminaires, example embodiments can be used with any other type of luminaire, including but not limited to pendent lights, troffers, and ceiling fan lights.

As discussed below, example internal lighting modules can be used for one or more of any of a number of purposes. For example, an internal lighting module can be used as a light source of the luminaire, for instance to provide emergency egress lighting during an outage or other emergency condition. Examples of other types of use for which an internal lighting module can be used can include, but are not limited to, as a night light, as an accent light, to provide low-level lighting, to provide mood lighting, to accompany music being broadcast or a movie being played, as an indicator light (e.g., an indicator of a network connection, an indicator of the occurrence of an event, an indicator of the occurrence of a status, etc.), and/or as a communication light (as when the light sources are used in conjunction with the digital assistant).

Luminaires with example internal lighting modules can be located in one or more of any of a number of environments. Examples of such environments can include, but are not limited to, indoors, outdoors, a parking garage, a hallway, a theater, an office space, a manufacturing plant, a warehouse, and a storage facility, either climate-controlled or non-climate-controlled. In some cases, the example embodiments discussed herein can be used in any type of hazardous environment, including but not limited to an airplane hangar, a drilling rig (as for oil, gas, or water), a production rig (as for oil or gas), a refinery, a chemical plant, a power plant, a mining operation, a wastewater treatment facility, and a steel mill.

Luminaires with example internal lighting modules can be integrated into any of a number of different structures. Such structures can include, but are not limited to, a pole, an I-beam, drywall, a ceiling tile, wood studs, a tree, a wall, and a building facade. Luminaires with example internal lighting modules (including components thereof) can be made of one or more of a number of suitable materials to allow the luminaire to meet certain standards and/or regulations while also maintaining durability in light of the one or more conditions under which the luminaires and/or other associated components of the luminaire can be exposed. Examples of such materials can include, but are not limited to, aluminum, stainless steel, fiberglass, glass, plastic, polymer, ceramic, and rubber.

Example internal lighting modules, or portions thereof, described herein can be made from a single piece (as from a mold, injection mold, die cast, or extrusion process). In addition, or in the alternative, example internal lighting modules can be made from multiple pieces that are mechanically coupled to each other. In such a case, the multiple pieces can be mechanically coupled to each other using one or more of a number of coupling methods, including but not limited to epoxy, welding, fastening devices, compression fittings, mating threads, snap fittings, and slotted fittings. One or more pieces that are mechanically coupled to each other can be coupled to each other in one or more of a number of ways, including but not limited to fixedly, hingedly, removeably, slidably, and threadably.

Components and/or features described herein can include elements that are described as coupling, fastening, securing, abutting against, in communication with, or other similar terms. Such terms are merely meant to distinguish various elements and/or features within a component or device and are not meant to limit the capability or function of that particular element and/or feature. For example, a feature described as a “coupling feature” can couple, secure, fasten, abut against, and/or perform other functions aside from merely coupling.

A coupling feature (including a complementary coupling feature) as described herein can allow one or more components and/or portions of a luminaire (including an example internal lighting modules) to become coupled, directly or indirectly, to a structure (e.g., a pole) and/or some other component of the luminaire. A coupling feature can include, but is not limited to, a clamp, a portion of a hinge, an aperture, a recessed area, a protrusion, a hole, a slot, a tab, a detent, and mating threads. One portion of a luminaire can be coupled to a structure and/or some other component of the luminaire by the direct use of one or more coupling features.

In addition, or in the alternative, a portion of a luminaire can be coupled to a structure and/or some other component of the luminaire using one or more independent devices that interact with one or more coupling features disposed on a component of the luminaire. Examples of such devices can include, but are not limited to, a pin, a hinge, a C-shaped compression spring, a fastening device (e.g., a bolt, a screw, a rivet), epoxy, glue, adhesive, and a spring. One coupling feature described herein can be the same as, or different than, one or more other coupling features described herein. A complementary coupling feature as described herein can be a coupling feature that mechanically couples, directly or indirectly, with another coupling feature.

In the foregoing figures showing example embodiments of internal lighting modules, one or more of the components shown may be omitted, repeated, and/or substituted. Accordingly, example embodiments of internal lighting modules should not be considered limited to the specific arrangements of components shown in any of the figures. For example, features shown in one or more figures or described with respect to one embodiment can be applied to another embodiment associated with a different figure or description.

In certain example embodiments, luminaires having example internal lighting modules are subject to meeting certain standards, regulations, and/or other requirements. For example, the National Electric Code (NEC), the National Electrical Manufacturers Association (NEMA), the International Electrotechnical Commission (IEC), the Federal Communication Commission (FCC), Underwriters Laboratories (UL), and the Institute of Electrical and Electronics Engineers (IEEE) set standards as to luminaires, wiring, and electrical connections. Use of example embodiments described herein meet (and/or allow the luminaire to meet) such standards when applicable.

If a component of a figure is described but not expressly shown or labeled in that figure, the label used for a corresponding component in another figure can be inferred to that component. Conversely, if a component in a figure is labeled but not described with respect to that figure, the description for such component can be substantially the same as the description for a corresponding component in another figure. The numbering scheme for the various components in the figures herein is such that each component is a three-digit number, and corresponding components in other figures have the identical last two digits.

In addition, a statement that a particular embodiment (e.g., as shown in a figure herein) does not have a particular feature or component does not mean, unless expressly stated, that such embodiment is not capable of having such feature or component. For example, for purposes of present or future claims herein, a feature or component that is described as not being included in an example embodiment shown in one or more particular drawings is capable of being included in one or more claims that correspond to such one or more particular drawings herein.

Example embodiments of internal lighting modules will be described more fully hereinafter with reference to the accompanying drawings, in which example embodiments of internal lighting modules are shown. Internal lighting modules may, however, be embodied in many different forms and should not be construed as limited to the example embodiments set forth herein. Rather, these example embodiments are provided so that this disclosure will be thorough and complete, and will fully convey the scope of internal lighting modules to those of ordinary skill in the art. Like, but not necessarily the same, elements (also sometimes called components) in the various figures are denoted by like reference numerals for consistency.

Terms such as “first”, “second”, “primary,” “secondary,” “above”, “below”, “inner”, “outer”, “distal”, “proximal”, “end”, “top”, “bottom”, “upper”, “lower”, “side”, “left”, “right”, “front”, “rear”, and “within”, when present, are used merely to distinguish one component (or part of a component or state of a component) from another. Such terms are not meant to denote a preference or a particular orientation. Such terms are not meant to limit embodiments of internal lighting modules. In the following detailed description of the example embodiments, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

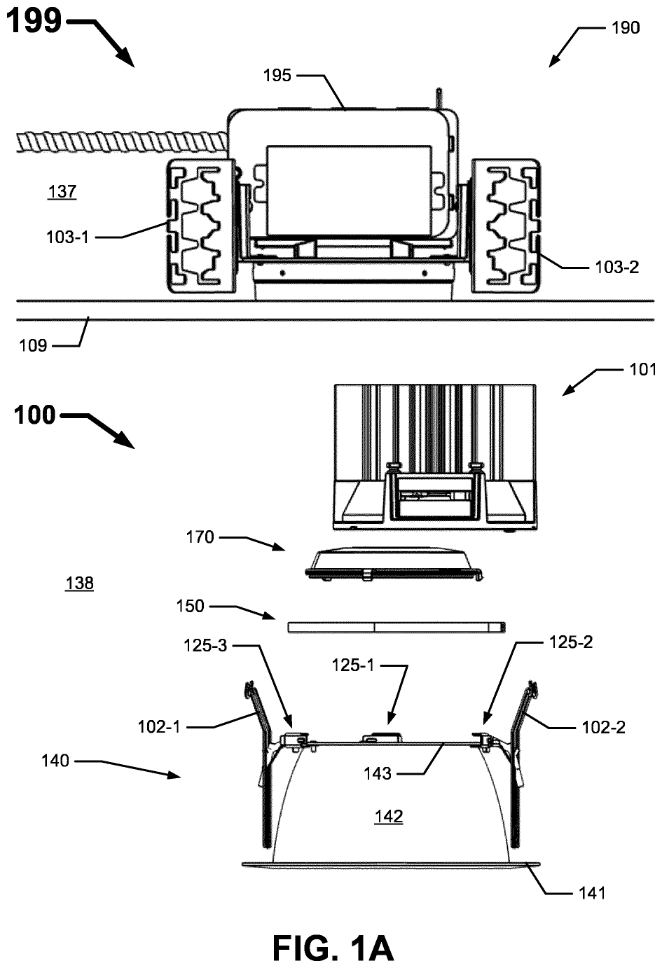

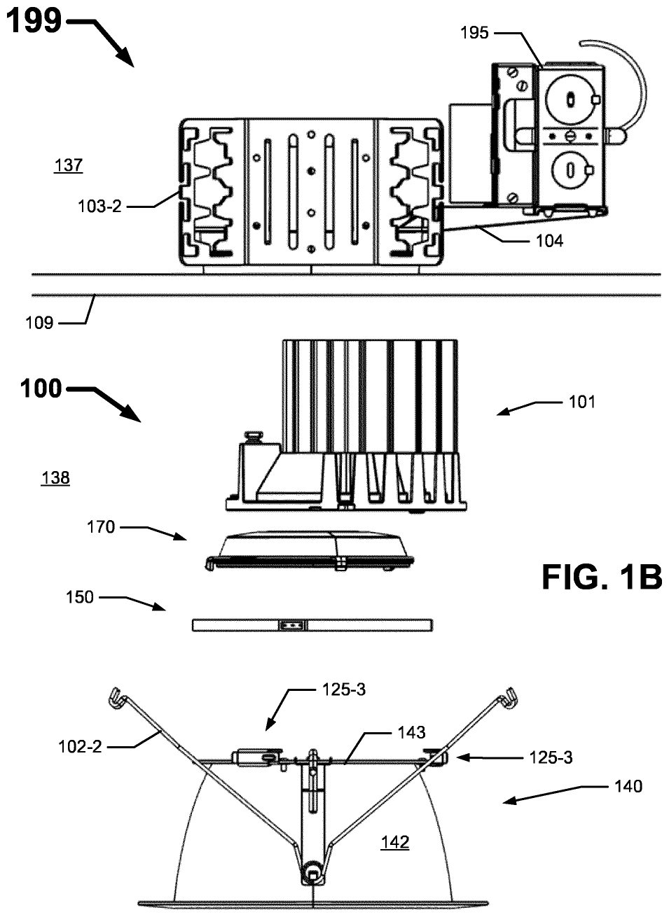

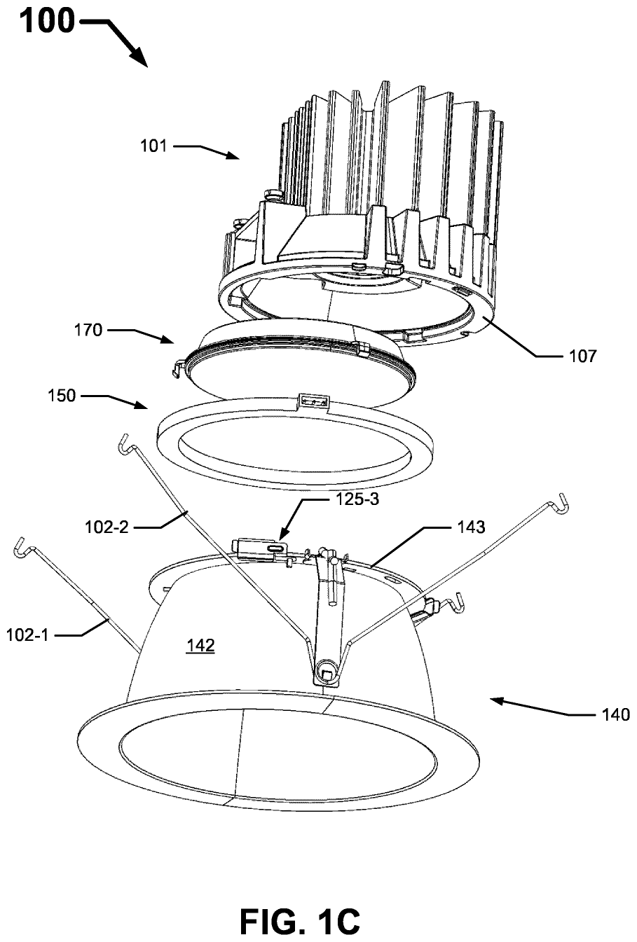

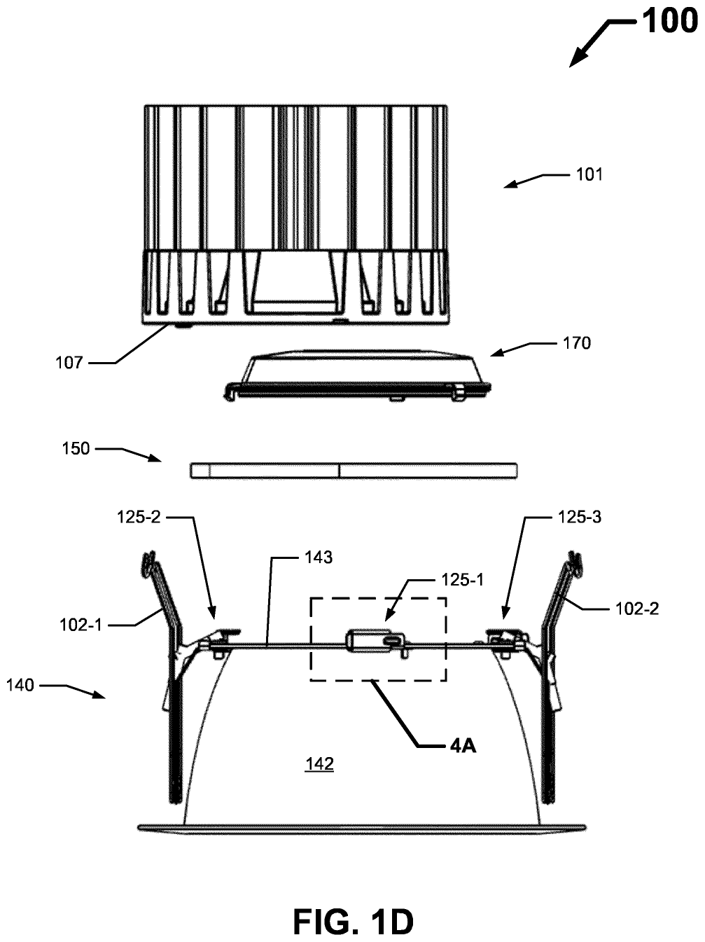

FIGS. 1A through 1D show various views of part of a lighting system 199 that includes a recessed luminaire 100 according to certain example embodiments. Specifically, FIG. 1A shows an exploded front view of the lighting system 199. FIG. 1B shows an exploded side view of the lighting system 199. FIG. 1C shows an exploded bottom perspective view of the recessed luminaire 100 from the lighting system 199 FIGS. 1A and 1B. FIG. 1D shows an exploded front view of the recessed luminaire 100 from the lighting system 199 FIGS. 1A and 1B. In addition to the recessed luminaire 100, the lighting system 199 includes a structure 109 in which part of the recessed luminaire 100 is disposed.

The recessed luminaire 100 of the lighting system 199 of FIGS. 1A through 1D is installed by being disposed in an aperture in a structure 109 (in this case, a ceiling tile or drywall forming a ceiling). As a result, most of the recessed luminaire 100 is positioned in a volume of space 137 (e.g., a plenum space) above the structure 109, while the remainder of the recessed luminaire 100 is in a different volume of space 138 below the structure 109. The recessed luminaire 100 includes a frame 104, a trim 140, an enclosure 101, an optical assembly 170, a junction box 195, an example internal lighting module 150, a pair of torsion springs 102 (torsion spring 102-1 and torsion spring 102-2), and a pair of mounting brackets 103 (mounting bracket 103-1 and mounting bracket 103-2).

The enclosure 101 can serve multiple functions. For example, the enclosure 101 can include an internal cavity inside of which can be housed one or more electrical components, including but not limited to a power supply (e.g., a driver) and a controller. As another example, the heat sink assembly 101 can include heat sinking material (e.g., thermally conductive metal) configured in such a way (e.g., multiple fins) to absorb heat generated by one or more heat-generating components (e.g., a driver, light sources) and dissipate the heat into the adjacent environment 137 (e.g., a plenum space).

As yet another example, the enclosure 101 can have a profile shape (e.g., substantially circular (as in this case), substantially square, substantially oval) in a horizontal plane at its bottom (distal) end 107 (e.g., a flange, a collar). The profile shape of the bottom end 107 of the enclosure 101 can be planar or three-dimensional. As still another example, the enclosure 101 can have a lower cavity, adjacent to the bottom end 107, that houses one or more light sources of the recessed luminaire 100. Such light sources are primary light sources for the recessed luminaire 100 and can be configured to provide general illumination in the volume of space 138. In alternative cases, the primary light sources can be configured to provide any of a number of other types of illumination (e.g., accent lighting, indirect lighting, task lighting) into the volume of space 138. A primary light source can use any type of lighting technology, including but not limited to light-emitting diodes (LEDs), incandescent, halogen, fluorescent, and sodium vapor.

The optical assembly 170 of the recessed luminaire 100 can include one or more components (e.g., a reflector, a lens) that manipulates the light emitted by the primary light sources of the enclosure 101 before the light reaches the volume of space 138. The optical assembly 170 can allow light generated by the primary light sources to be emitted directly and/or indirectly into the volume of space 138. The optical assembly 170 is configured to fit within the cavity at the bottom end 107 of the enclosure 101, adjacent to the light sources.

There are two torsion springs 102 (torsion spring 120-1 and torsion spring 120-2) of the recessed luminaire 100. The torsion springs 102 are configured to help secure the recessed luminaire 100 within the volume of space 137 (e.g., a plenum space) above the structure 109. There are also two mounting brackets 103 (mounting bracket 103-1 and mounting bracket 103-2) of the recessed luminaire 100. Each mounting bracket 103 is mounted to the frame 104. The mounting brackets 103 are configured to help secure the recessed luminaire 100 within the volume of space 137 above the structure 109.

The junction box 195 is used to house one or more electrical components of the recessed luminaire 100 that are not disposed in the enclosure 101. Such electrical components housed in the junction box 195 can be electrically coupled to one or more electrical components disposed in the enclosure 101 and/or the example internal lighting module 150. Examples of electrical components housed in the junction box 195 can include, but are not limited to, an emergency power source (e.g., a battery), a terminal block, a luminaire controller, and a sensor device. The frame 104 of the recessed luminaire 100 is positioned in the volume of space 137 and has disposed thereon or therein multiple components of the recessed luminaire 100, such as the junction box 195, the brackets 103, the trim 140, and the enclosure 101.

The trim 140 has a trim body 142, a trim flange 143 that is disposed at the top (proximal) end of the trim body 142, and a trim flange 141 that is disposed at the bottom (distal) end of the trim body 142. The trim flange 141 of the trim 140 is configured to be disposed in the volume of space 138 in which light from the recessed luminaire 100 is emitted, and the remainder of the trim 140 is disposed in the volume of space 137 located above the structure 109. In some cases, the trim flange 141 abuts against a bottom surface of the structure 109. The trim flange 143 of the trim 140 has a profile shape (e.g., substantially circular (as in this case), substantially square, substantially oval) in a horizontal plane that is substantially the same (e.g., in terms of shape, in terms of inner diameter, in terms of outer diameter) as the profile shape of the bottom end 107 of the enclosure 101. The profile shape of the trim flange 143 of the trim 140 can be planar or three-dimensional.

The trim flange 143 can have disposed thereon any of a number of securing member assemblies 125 to directly or indirectly couple the trim flange 143 of the trim 140 to the bottom end 107 of the enclosure 101. Each securing member assembly 125 can have any of a number of configurations and/or positions. For example, in this case, there are three equidistantly spaced securing member assemblies 125 (securing member assembly 125-1, securing member assembly 125-2, and securing member assembly 125-3), each in the form of a rotatable C-shaped compression spring, that are used to indirectly couple the trim flange 143 of the trim 140 to the bottom end 107 of the enclosure 101. In alternative embodiments, in addition to having different numbers and configurations, the securing member assemblies 125 can have any other spacing around the circumference of the enclosure 101, the trim 140, and/or the internal lighting module 150.

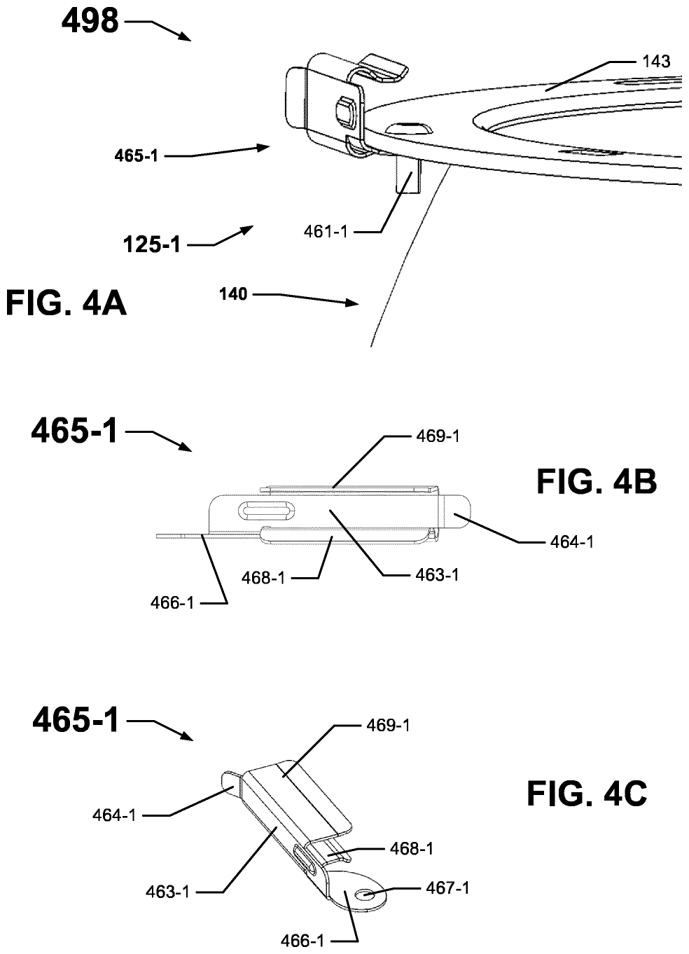

Rather than being disposed on the trim flange 143, a securing member assembly 125 can be disposed on another component (e.g., the bottom end 107 of the enclosure 101, the housing 251 of the internal lighting module 150) of the recessed luminaire 100. As another alternative, a securing member assembly 125 can be an independent component (e.g., not an assembly) that is not disposed on (e.g., hingedly coupled to) any other component of the recessed luminaire 100. When there are multiple securing members assemblies 125, as in this case, one securing member assembly 125 can have the same or a different configuration compared to the configuration of the other securing member assemblies 125. In this case, all three securing member assemblies 125 are configured identically with respect to each other. More details about the securing member assemblies 125 in this case are discussed below with respect to FIGS. 4A through 4C.

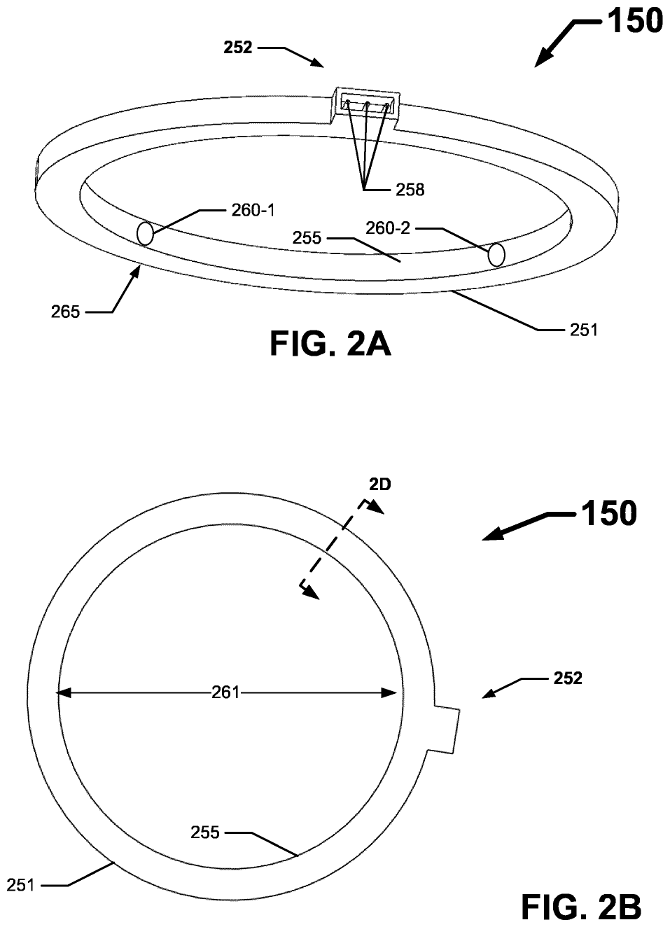

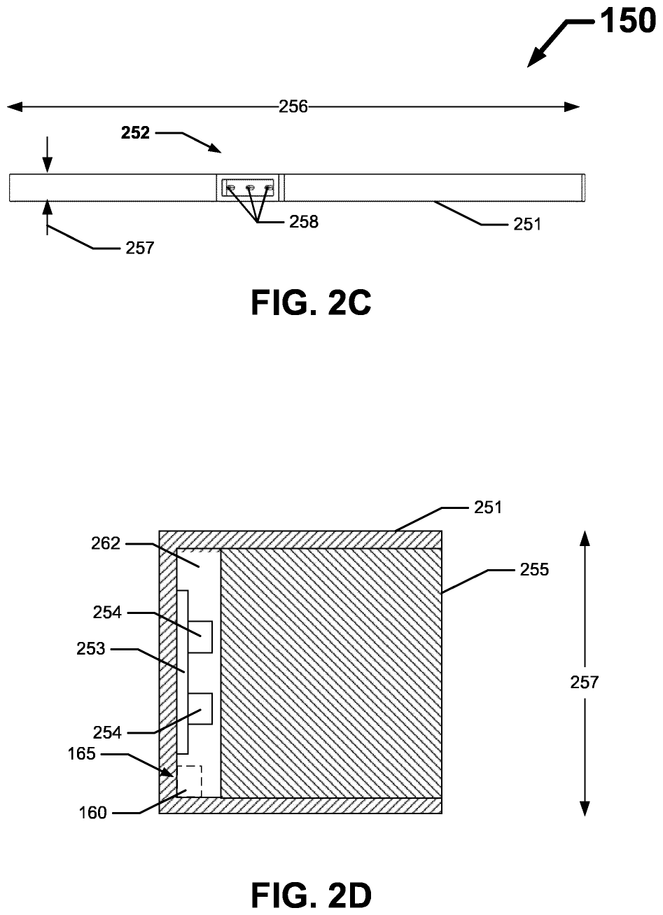

In recessed luminaires currently known in the art, the example internal lighting module 150 is not part of the recessed luminaire, and the bottom end 107 of the enclosure 101 abuts against and/or is coupled to the trim flange 143 of the trim 140. By contrast, in the recessed luminaire 100 of FIGS. 1A through 1D, the example internal lighting module 150 is disposed between the enclosure 101 and the trim 140. As a result, in cases where the recessed luminaire 100 is being retrofitted with the example internal lighting module 150, the securing member assemblies 125 may need to be modified or changed to accommodate the extra thickness added by the height of the example internal lighting module 150. More details about the example internal lighting module 150 are provided below with respect to FIGS. 2A through 2D.

FIGS. 2A through 2D show various views of the internal lighting module 150 of the recessed luminaire of FIGS. 1A through 1D. Specifically, FIG. 2A shows a bottom perspective view of the internal lighting module 150. FIG. 2B shows a top view of the internal lighting module 150. FIG. 2C shows a side view of the internal lighting module 150. FIG. 2D shows a cross-sectional view of the internal lighting module 150.

Referring to FIGS. 1A through 2D, the internal lighting module 150 of the recessed luminaire 100 can have any of a number of configurations. For example, as in this case, the internal lighting module 150 can have a housing 251, a light guide 255, an optional testing interface 165, another testing interface 265, and an electrical connection interface 252. The optional testing interface 165 includes an optional sensor device 160. The testing interface 265 includes multiple (in this case, 4) sensor devices 260. The housing 251 of the internal lighting module 150 is configured to house one or more components (e.g., a power source, one or more light sources 254, the light guide 255) of the internal lighting module 150.

The housing 251 of the internal lighting module 150 can be configured to have a profile shape that substantially matches (e.g., in terms of shape (e.g., substantially circular, substantially square, substantially oval), in terms of size, in terms of dimensionality) that of the trim flange 143 of the trim 140 and the bottom end 107 of the enclosure 101 of the recessed luminaire 100. In this case, the housing 251 is cylindrical having a profile shape that is circular in the horizontal plane. The housing 251 has an outer diameter 256 and an inner diameter 261. The housing 251 also has a height 257 that is substantially constant between and including the outer diameter 256 and the inner diameter 261. In certain example embodiments, the height 257 is designed to be minimal to avoid elongating the recessed luminaire 100.

As shown by the cross-sectional view of FIG. 2D, the housing 251 is C-shaped and forms a cavity 262 that is open ended along the inner diameter 261. Disposed against the back wall of the housing 251 is a circuit board 253, and multiple light sources 254 are disposed on the circuit board 253. Disposed adjacent to the light sources 254 is the light guide 255, which extends to substantially the inner perimeter of the housing 251. The light guide 255 is configured to manipulate (e.g., reflect, refract) the light that is generated by the light sources 254 and direct the light away from an inner perimeter of the housing 251 (i.e., toward the space bounded by the inner diameter 261 of the housing 251). The light guide 255 can be a single piece disposed along some or all of the entire cavity 262 of the housing 251. Alternatively, the light guide 255 can be multiple pieces or segments disposed within the cavity 262 of the housing 251. In certain example embodiments, the housing 251 of the internal lighting module 150 is made of one or more of a number of thermally conductive materials.

In certain example embodiments, the light sources 254 operate using power provided by a power source (e.g., an emergency power source) that is located external to the housing 251 of the internal lighting module 150. Such power can be provided directly or indirectly to the light sources 254 using the electrical connection interface 252 of the internal lighting module 150. The electrical connection interface 252 can have any of a number of configurations. For example, in this case, the electrical connection interface 252 is a connector end (in this case, having a male configuration with multiple electrically conductive pins 258). In this case the configuration of the connector end of the electrical connection interface 252 is configured to couple to a complementary connector end disposed on the end of an electrical cable that is electrically coupled to the power source external to the housing 251. The electrical connection interface 252 in this case extends outward from the outer surface of the housing 251. In alternative embodiments, as when the source (e.g., an emergency power source) providing power to the internal lighting module 150 is disposed in the enclosure 101 of the recessed luminaire 100, the electrical connection interface 252 can be disposed on (and in some cases extend outward from) another surface (e.g., the top surface) of the housing 251 to couple to a complementary electrical connection interface (e.g., disposed on the bottom end 107 of the enclosure 101).

The test interface 265 and the optional test interface 165 are each configured to trigger a test of the functionality of the internal lighting module 150 or portions thereof. A test interface (e.g., test interface 165, test interface 265) can be triggered by direct physical interaction with a user, by indirect physical interaction with a user, by remote control (e.g., purely electronic means), and/or by any other suitable method and/or mechanism. If the test interface 165 exists in the internal lighting module 150, then the test interface 265 (including all of the sensor devices 260) can be omitted from the internal lighting module 150.

The sensor device 160 of the test interface 165 and each of the sensor devices 260 of the test interface 265 of the internal lighting module 150 can be configured to include one or more sensors that measure one or more parameters. For example, the sensor devices 260 can be photocells that are configured to detect a laser directed at them by a user. When such a sensor device 260 detects a laser, a loss of power can be simulated and engage an emergency operation, thereby testing the functionality of the light sources 254 of the internal lighting module 150. The test interface 265 of the internal lighting module 150 can include any of a number of sensor devices 260. In this case, there are four sensor devices 260, although only sensor device 260-1 and sensor device 260-2 are visible in FIGS. 2A through 2D.

As another example, the sensor device 160 can be a magnetic reed switch that is configured to detect a minimal magnetic field, which can be brought within proximity of the sensor device 160 by a user positioning a magnetized object sufficiently proximate to the sensor device 160. When such a sensor device 160 detects a minimal magnetic field, the magnetic reed switch engages, and a loss of power can be simulated and engage an emergency operation, thereby testing the functionality of the light sources 254 of the internal lighting module 150. The test interface 165 of the internal lighting module 150 can include any of a number of sensor devices 160. In this case, there is a single sensor device 160.

Each sensor device 260 of the test interface 265 and the sensor device 160 of the test interface 165 can be positioned at any location with respect to the housing 251 or other component (e.g., the light guide 255) of the internal lighting module 150. In this case, the sensor devices 260 are disposed at the distal end (along the inner diameter 261) of the housing 251, forming breaks between segments of the light guide 255. Alternatively, each sensor device 260 can be integrated into the distal end of a single continuous light guide. The four sensor devices 260 in this case are distributed equidistantly and aligned with the inner diameter 261 of the housing 251. Also, the sensor device 160 is disposed in the cavity 262 within the housing 251 at a location that can detect a minimal magnetic field, emitted by a magnetic object positioned proximate to the luminaire 100 by a user, to operate the magnetic reed switch. In certain example embodiments, the sensor devices 260 are positioned at a location that is accessible to a laser directed by a user, do not affect light emitted by the recessed luminaire 100 into the volume of space 138 (and in some cases also do not affect light emitted by the light sources 254 of the internal lighting module 150), and are electrically coupled to a controller of the internal lighting module 150. Also, the sensor device 160 is disposed at a location in a cavity 262 that does not affect light emitted by the light sources 254 of the internal lighting module 150.

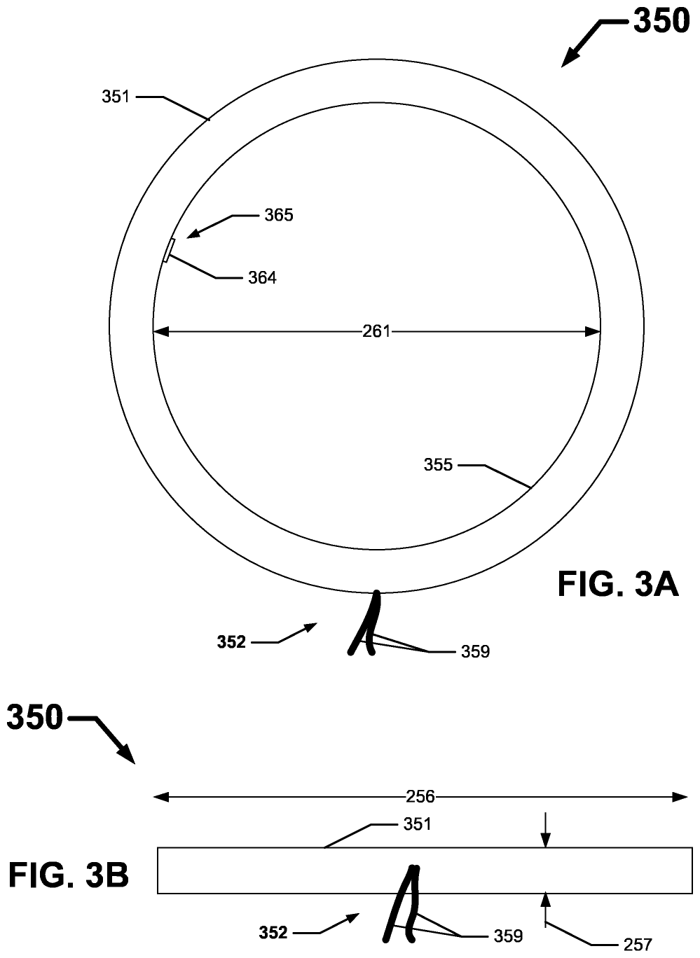

FIGS. 3A and 3B show various views of another internal lighting module 350 according to certain example embodiments. Specifically, FIG. 3A shows a top view of the internal lighting module 350. FIG. 3B shows a side view of the internal lighting module 350. Referring to FIGS. 1A through 3B, the internal lighting module 350 of FIGS. 3A and 3B is substantially similar to the internal lighting module 150, except as described below.

For example, the internal lighting module 350 of FIGS. 3A and 3B has a housing 351 that is configured to house one or more components (e.g., a power source, one or more light sources, a light guide 255) of the internal lighting module 350. The housing 351 of the internal lighting module 350 is configured to have a profile shape that substantially matches (e.g., in terms of shape, in terms of size) that of the trim flange 143 of the trim 140 and the bottom end 107 of the enclosure 101 of the recessed luminaire 100. In this case, the housing 351 is cylindrical, having a profile shape that is circular in the horizontal plane.

The housing 351 has the outer diameter 256 and the inner diameter 261. The housing 351 also has the height 257 that is substantially constant between and including the outer diameter 256 and the inner diameter 261. In other words, in this case, the housing 351 has substantially the same shape and size as the housing 251 of FIGS. 2A through 2D. In alternative embodiments, the housing 351 can have a different shape and/or one or more different dimensions compared to the housing 251 of FIGS. 2A through 2D. The housing 351 is C-shaped and forms a cavity that is open ended along the inner diameter 261. Disposed against the back wall of the housing 351 can be a circuit board and multiple light sources are disposed on the circuit board. Disposed adjacent to the light sources can be the light guide 355, which extends to substantially the inner perimeter of the housing 351.

The electrical connection interface 352 in this case is configured differently relative to the electrical connection interface 252. Specifically, in this case, the electrical connection interface 352, rather than being configured as a connector end, is configured as multiple (in this case, two) electrical conductors 359 that extend outward from the outer surface of the housing 351. Each of the electrical conductors 359 is configured to couple, directly or indirectly, to another component (e.g., that are electrically coupled to the power source external to the housing 251) of the recessed luminaire 100.

The distal end of each of the electrical conductors 359 can be bare exposed wires (e.g., that can be coupled to (e.g., twisted together with) other electrical conductors using wire nuts), wires crimped with a spade connector (e.g., for being screwed into terminals of a terminal block that is electrically coupled to other terminals to which other electrical conductors are screwed), or wires that are configured in any of a number of other ways to enable the coupling of the electrical conductors 359 to provide power to electrical components of the internal lighting module 350. In certain example embodiments, the electrical connection interface (e.g., electrical connection interface 252, electrical connection interface 352) (including portions thereof) are suitable to meet applicable standards and/or regulations. For example, the electrical conductors 359 of the electrical connection interface 352 can be plenum rated.

Also, the internal lighting module 350 does not have any sensor devices (e.g., sensor device 160, sensor devices 260), and so the test interface 365 takes on a different form compared to what is used with the internal lighting module 150 of FIGS. 2A through 2D. Rather than indirect interaction to trigger the test interface 365, the internal lighting module 350 of FIGS. 3A and 3B includes a test interface 365 in the form of a physical interface 364 that can serve the same function as the sensor device 160 and the sensor devices 260 of the internal lighting module 150. In other words, when the physical interface 364 of the test interface 365 is directly physically engaged (e.g., depressed in the case of a pushbutton, toggled in the case of a switch) by a user, a loss of power can be simulated and engage an emergency operation, thereby testing the functionality of the light sources of the internal lighting module 350.

The physical interface 364 of the test interface 365 can be placed at any location (e.g., at the distal end of the housing 351 adjacent to the light guide 355) with respect to the internal lighting module 350 that is accessible to a user. In certain example embodiments, the physical interface 364 of the test interface 365 is positioned at a location that is physically accessible to a user, does not affect light emitted by the recessed luminaire 100 into the volume of space 138 (and in some cases also does not affect light emitted by the light sources of the internal lighting module 350), and is electrically coupled to a controller of the internal lighting module 350.

In alternative embodiments, the physical interface 364 of the test interface 365 can have any of a number of configurations known to those of ordinary skill in the art to enable manual testing of the internal lighting module 350 through physical interaction. For example, the physical interface 364 of the test interface 365 can be or include a fingerprint reader. As another example, the physical interface 364 of the test interface 365 can be or include a toggle switch. As yet another example, the physical interface 364 of the test interface 365 can be or include a pushbutton.

As discussed above, the example internal lighting modules (e.g., internal lighting module 150, internal lighting module 350) discussed herein are disposed between the trim 140 and the enclosure 101 of the recessed luminaire 100. FIGS. 4A through 4C show a subassembly 498 that includes the securing member assembly 125-1 of FIGS. 1A through 1D. Specifically, FIG. 4A shows a top perspective view of the subassembly 498. FIGS. 4B and 4C show a rear view and a perspective view, respectively, of a securing member 465-1 of the securing member assembly 425-1.

Referring to FIGS. 1 through 4C, the subassembly 498 shows the securing member assembly 125-1 coupled to the trim flange 143 of the trim 140. The securing member assembly 125-1 includes multiple components. For example, in this case, the securing member assembly 125-1 includes the securing member 465-1 and a coupling feature 461-1 in the form of a rivet. The securing member assembly 425-1 in this case is movably (e.g., rotatably) coupled to the trim flange 143 of the trim 140. The trim flange 143 of the trim 140 is substantially planar. Where each securing member assembly 125 (in this case, securing member assembly 125-1) is located relative to the trim flange 143, there is a coupling feature (hidden from view) in the form of an aperture that traverses the trim flange 143. The shape and size of the coupling feature in the trim flange 143 can be configured to complement (e.g., has substantially the same shape and size as) the coupling feature 467-1, also in the form of an aperture, disposed in the coupling body 466-1 of the securing member 465-1. The independent coupling feature 461-1 of the securing member assembly 125-1 engages the coupling feature of the trim flange 143 and the coupling feature 467-1 of the securing member 465-1.

As stated above, the securing member 465-1 of the securing member assembly 125-1 is configured to retain multiple components (in this case, the trim flange 143 of the trim 140, an internal lighting module (e.g., internal lighting module 150, internal lighting module 350), and the bottom end 107 of the enclosure 101) in a substantially fixed position relative to each other. The securing member 465-1 can have any of a number of configurations. For example, in this case, the securing member 465-1 is a C-shaped compression spring having a back wall 463-1, a top wall 469-1 that extends from the top of the back wall 463-1, and a bottom wall 468-1 that extends from the bottom of the back wall 463-1. The securing member 465-1 in this example also includes a control feature 464-1 that extends from one end of the back wall 463-1 and the coupling body 466-1 (along with the coupling feature 467-1) that is disposed on the opposite end of the back wall 463-1 relative to the control feature 464-1. In this spring clip configuration, the top wall 469-1 and the bottom wall 468-1 are substantially parallel with each other and apply a compressive force toward each other.

The back wall 463-1, the top wall 469-1, and the bottom wall 468-1 of the securing member 465-1 can be formed from a single piece or from multiple pieces that are coupled to each other. In either case, the top wall 469-1 and/or the bottom wall 468-1 can be resiliently flexible with respect to the back wall 463-1. In other words, the distance between the top wall 469-1 and the bottom wall 468-1 can be temporarily expanded so that one or more components (e.g., the trim flange 143 of the trim 140, an internal lighting module (e.g., internal lighting module 150, internal lighting module 350), and the bottom end 107 of the enclosure 101) of the recessed luminaire 100 can be disposed within the space formed between the back wall 463-1, the top wall 469-1, and the bottom wall 468-1. Subsequently, distance between the top wall 469-1 and the bottom wall 468-1 can be decreased toward a default position in a manner that the other components of the recessed luminaire 100 are retained therein.

In certain example embodiments, the control feature 464-1 is configured to allow a user to rotate or otherwise move, without the use of a tool, the securing member 465-1 so that the securing member 465-1 engages with and/or disengages from the trim flange 143 of the trim 140 and the bottom end 107 of the enclosure 101. In this case, the control feature 464-1 is an extension of one side of the back wall 463-1 that is bent backward (away from the direction in which the top wall 469-1 and the bottom wall 468-1 extend) at a slight angle relative to the back wall 463-1. In alternative embodiments, the control feature 464-1 can be a separate piece that is mechanically coupled to the back wall 463-1 and/or have any of a number of other configurations that can allow a user to move the securing member 465-1 relative to the trim 140, with or without the use of a tool.

The coupling body 466-1 and the associated coupling feature 467-1 of the securing member 465-1 are configured to allow the securing member 465-1 to be movably (in this case, rotatably) coupled to the trim flange 143 of the trim 140. The coupling body 466-1 and the coupling feature 467-1 can have any of a number of characteristics and configurations. For example, in this case, the coupling body 466-1 is a planar section that extends from the back wall 463-1 and is substantially planar with at least part of the bottom wall 468-1. In this case, the coupling body 466-1 and the back wall 463-1 can be formed from a single piece, but in alternative embodiments they are separate pieces that are mechanically coupled to each other. In some cases, the coupling body 466-1 and the coupling feature 467-1 are omitted from the securing member 465-1.

As discussed above, the coupling feature 467-1 in this case is an aperture that traverses the coupling body 466-1 and is configured to receive an independent coupling feature 461-1 (e.g., a rivet (as in this example), a screw, a hinge). In alternative embodiments, the coupling feature 467-1 is configured to provide direct coupling to the trim flange 143 of the trim 140. The location of the coupling feature 467-1 in the coupling body 466-1 in this case is in the approximate center to provide stability and allow for unobstructed rotation of the securing member 465-1 with respect to the other components (e.g., trim flange 143 of the trim 140, the bottom end 107 of the enclosure 101) that are disposed within the space formed by the back wall 463-1, the top wall 469-1, and the bottom wall 468-1 at the time.

When a recessed luminaire is retrofitted with an example internal lighting module (e.g., internal lighting module 150), the height of the securing member 465 of the securing member assembly 125 needs to increase to account for the thickness (e.g., ¼ inch, ½ inch, 1 inch) of the internal lighting module. As a result, each securing member assembly 125 (or portions thereof) can be replaced in order to accommodate the addition of the internal lighting module to the recessed luminaire 100. In such cases, each securing member assembly 125 and/or other components of the recessed luminaire 100 can be configured to allow for such changes.

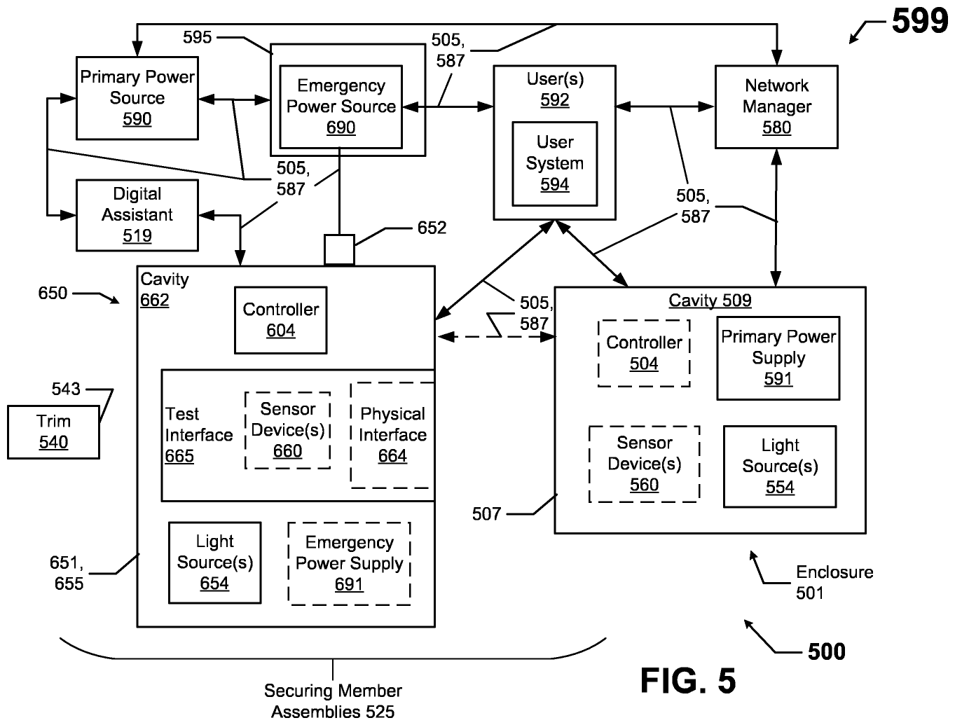

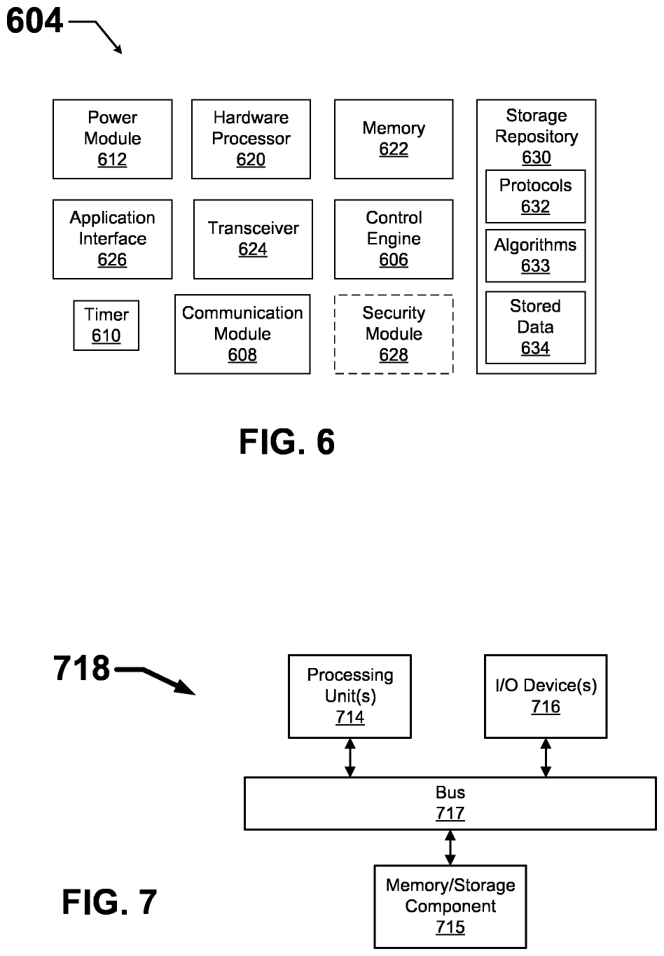

FIG. 5 shows a diagram of a system 599 that includes a recessed luminaire according to certain example embodiments. FIG. 6 shows a system diagram of the controller 504 of the internal lighting module 650 of the system of FIG. 5. The system 599 includes a recessed luminaire 500, a network manager 580, a primary power source 590, a digital assistant 519, and one or more users 592. The recessed luminaire 500 can include multiple components. In this case, the recessed luminaire 500 includes an internal lighting module 650, a junction box 595, and an enclosure 501. Each user 592 can include one or more user systems 594.

The components shown in FIGS. 5 and 6 are not exhaustive, and in some embodiments, one or more of the components shown in FIGS. 5 and 6 may not be included in the example system 599. Any component of the system 599 can be discrete or combined with one or more other components of the system 599. Also, one or more components of the system 599 can have different configurations. For example, one or more sensor devices 560 can be disposed within or disposed on other components (e.g., the trim 540) of the recessed luminaire 500 aside from the enclosure 501. As another example, some of the functionality of the controller 604 of the internal lighting module 650 and the luminaire controller 504 can be shared.

Referring to FIGS. 1A through 6, the junction box 595, the enclosure 501, the internal lighting module 650, the trim 540, and the one or more securing member assemblies 525 of the system 599 can be substantially the same as the corresponding components discussed above with respect to FIGS. 1A through 4C. A component of the system 599 of FIG. 5 can be electrically and/or communicably coupled to one or more other components of the system 599 using power transfer links 587 and/or communication links 505. Each communication link 505 can include wired (e.g., Class 1 electrical cables, Class 2 electrical cables, electrical connectors, Power Line Carrier, RS485) and/or wireless (e.g., Wi-Fi, Zigbee, ultra-wide band (UWB), VLC, laser transmissions, cellular networking, Bluetooth, Bluetooth Low Energy (BLE), WirelessHART, ISA100) technology. A communication link 505 can transmit signals (e.g., communication signals, control signals, data) between the controller 504, the controller 604, the sensor devices 560, the test interface 665 (including the sensor devices 660), the emergency power source 690, the network manager 580, the digital assistant 519, the primary power supply 591, the emergency power supply 691, the light sources 554, the light sources 654, the users 592 (including any associated user systems 594), and other components of the system 599.

Each power transfer link 587 can include one or more electrical conductors, which can be individual or part of one or more electrical cables. In some cases, as with inductive power, power can be transferred wirelessly using power transfer links 587. A power transfer link 587 can transmit power between the controller 504, the controller 604, the sensor devices 560, the test interface 665 (including the sensor devices 660), the emergency power source 690, the network manager 580, the digital assistant 519, the primary power supply 591, the emergency power supply 691, the light sources 554, the light sources 654, the users 592 (including any associated user systems 594), and other components of the system 599. Each power transfer link 587 can be sized (e.g., 12 gauge, 18 gauge, 4 gauge) in a manner suitable for the amount (e.g., 480V, 24V, 120V) and type (e.g., alternating current, direct current) of power transferred therethrough.

The primary power source 590 of the system 599 provides AC mains or other form of primary power to the recessed luminaire 500 (or portions thereof) during normal operating conditions. In some cases, the primary power source 590 can also provide power to one or more other components (e.g., the network manager 580, other luminaires) of the system 599. The primary power source 590 can include one or more of a number of components. Examples of such components can include, but are not limited to, an electrical cable, a connector end, a transformer, an inductor, a resistor, a capacitor, a diode, a transistor, a circuit breaker, a wall outlet, a wall switch, a fuse, and an independent source of generation (e.g., a photovoltaic solar generation system). The primary power source 590 can also include one or more components (e.g., a switch, a relay, a controller) that allow the primary power source 590 to control, be controlled by, and/or communicate with other components (e.g., a user system 594 of a user 592, the network manager 580) of the system 599.

A user 592 can be any person that interacts with luminaires, lighting systems, or components thereof. Examples of a user 592 may include, but are not limited to, a business owner, an engineer, an electrician, an instrumentation and controls technician, a mechanic, an operator, a property manager, a homeowner, a tenant, an employee, a consultant, a contractor, and a manufacturer's representative. A user 592 can use one or more user systems 594, which may include a display (e.g., a GUI). A user 592 (including an associated user system 594) can interact with (e.g., sends data to, receives data from) another component of the system 599 using the communication links 505. A user system 594 can be or include a laser pointer. In addition, or in the alternative, a user system 594 can be or include a smart phone, a laptop computer, an electronic tablet, and a specialized handheld device.

The network manager 580 is a device or component that controls all or a portion (e.g., a communication network, the controller 504) of the system 599 that includes the recessed luminaire 500 (including components thereof). For example, the network manager 580 can communicate (e.g., periodically, randomly) with the controller 604 of the internal lighting module 650 to determine the status of the internal lighting module 650 and/or the emergency power source 690. As another example, the network manager 580 can manage the internal lighting module 650, the emergency power source 690, other internal emergency lighting modules, and/or other emergency power sources during an outage to ensure that all paths of emergency egress are properly lit.

The network manager 580 can be substantially similar to the controller 504 and/or the controller 604, both as described below. For example, the network manager 580 can include a controller that has one or more components and/or similar functionality to some or all of the controller 504 and/or the controller 604. Alternatively, the network manager 580 can include one or more of a number of features in addition to, or altered from, the features of the controller 504 and/or the controller 604. As described herein, control and/or communication with the network manager 580 can include communicating with one or more other components (e.g., another luminaire) of the same system 599 or another system. In such a case, the network manager 580 can facilitate such control and/or communication. The network manager 580 can be called by other names, including but not limited to a master controller, a network controller, and an enterprise manager.

The digital assistant 519 of the system 599 is configured to be a voice-controlled virtual device. There are many shapes, sizes, and manufacturers of digital assistants in the current art. Often, the digital assistant 519 includes a ring or other shape of lighting that is illuminated to coincide with various actions (e.g., emitting sound through a speaker) of the digital assistant 519. The digital assistant 519 has the ability to communicate with and/or control various components (e.g., a user system 594, the controller 504) of the system 599 as well as other devices (e.g., an HVAC system, a stereo) outside the system 599. The digital assistant 519 can also perform other functions, including but not limited to providing information (e.g., current weather conditions), ordering goods and services, conducting research, and making reservations.

The junction box 595 of the recessed luminaire 500 in this case houses an emergency power source 690. As discussed above, the emergency power source 690 is configured to provide emergency power to certain components (e.g., the internal lighting module 650) of the recessed luminaire 500 when the primary power source 590 is unavailable (e.g., during an outage, during a failure of the primary power source 590). In some cases, the emergency power source 690 can also be configured to provide power (the same as emergency power, but not in an outage situation) to the optional emergency power supply 691. Alternatively, if the emergency power source 690 is configured to provide emergency power of a type (e.g., direct current) and level (e.g., 12V) of voltage used by the various components (e.g., the controller 604, the light sources 654), the emergency power supply 691 may be absent from the internal lighting module 650.

An example of the emergency power source 690 is a battery, a battery assembly, a supercapacitor, or other type of energy storage device. In some cases, the emergency power source 690 can be recharged periodically using power provided by the primary power source 590. In some cases, the emergency power source 690 can include or be coupled to a controller (e.g., controller 504, controller 604) to control such functions as charging the emergency power source 690 and determining when the emergency power source 690 should release emergency power. In some cases, when emergency egress lighting is not required or used in the system 599, the emergency power source 690 can be an optional secondary power source.

In alternative embodiments, the emergency power source 690 can be located outside of the junction box 595. For example, the emergency power source 690 can be located in the cavity 509 of the enclosure 501. As another example, the emergency power source 690 can be located in the cavity 662 of the internal lighting module 650. As yet another example, the emergency power source 690 can be located in another enclosure that is not part of the recessed luminaire 500. In some cases, the emergency power source 690 is distributed between multiple locations (e.g., one or more batteries in the junction box 595, one or more other batteries in the cavity 662 of the internal lighting module 650. In any case, the emergency power source 690 is coupled to the electrical connection interface 652 of the internal lighting module 650 using power transfer links 587 and, in some cases, also communication links 505. The power transfer links 587 (and communication links 505 if applicable) can be configured to complement the coupling features of the electrical connection interface 652.

The trim 540 of the recessed luminaire 500 includes a trim flange 543 at the top end of the trim 540. The trim 540 and the trim flange 543 can be substantially the same as the trim 140 and the trim flange 143 discussed above. The recessed luminaire 500 includes one or more securing member assemblies 525 that are substantially the same as the securing member assemblies 125 discussed above.

The internal lighting module 650 of the recessed luminaire 500 has one or more components disposed within the cavity 662 formed by the housing 651 and, in some cases, the light guide 655. In this case, one or more light sources 654, a controller 604, a test interface 665 (which can include one or more optional sensor devices 660 and/or an optional physical interface 664), and an emergency power supply 691 are disposed in the cavity 662. In alternative embodiments, one or more of these components can be disposed on the housing 651 and/or the light guide 655. In yet other alternative embodiments, one or more of these components can be disposed remotely from, but can be electrically and/or communicably coupled to another component of, the internal lighting module 650. The housing 651, the cavity 662, the light guide 655, the test interface 665, and the light sources 654 of FIG. 5 can be substantially similar to the corresponding components discussed above with respect to the internal lighting modules of FIGS. 2A through 3B.

In some cases, test interface 665 can include at least one of the optional sensor devices 660 can be substantially similar to the sensor devices 260 and/or the sensor device 160 of the test interface 265 discussed above with respect to FIGS. 2A through 2D. In alternative embodiments, the test interface 665 of the internal lighting module 650 can include an optional physical interface 664. In such a case, the physical interface 664 can be substantially the same as the physical interface 364 of FIGS. 3A and 3B. In some cases, the test interface 665 of the internal lighting module 650 can include both a physical interface 664 and one or more sensor devices 660 that are configured to enable a test of operating the light sources 654 and/or other components of the internal lighting module 650 during emergency conditions. Alternatively, either the test interface 665 or one or more sensor devices 660 can be used to test the internal lighting module 650.

In yet other alternative embodiments, the test interface 665 can include some other component that is integrated with the internal lighting module 650 to initiate a test of the internal lighting module 650. For example, the test interface 665 can be a software-based construct that is triggered by an instruction from the controller 604. For example, the controller 604 of the internal lighting module 650 can receive a communication (e.g., from a user system 594, from the network manager 580), using the communication links 505, to test the internal lighting module 650. In response, the controller 604 executes the test using software that makes up the test interface 665.

In certain example embodiments, the internal lighting module 650 includes one or more electrical connection interfaces 652. An electrical connection interface 652 can have any configuration that complements the configuration of the power transfer links 587 (and communication links 505 if applicable) of the emergency power source 690. Examples of an electrical connection interface 652 can include the electrical connection interface 252 of FIGS. 2A through 2D and the electrical connection interface 352 of FIGS. 3A and 3B. The electrical connection interface 652 of FIG. 5 can be substantially the same as the electrical connection interfaces discussed above.

The one or more sensor devices 660 of the test interface 665 of the internal lighting module 650 can include one or more of any type of sensor that measure one or more parameters. Examples of types of sensors of a sensor device 660 can include, but are not limited to, a passive infrared sensor, a photocell, a differential pressure sensor, a humidity sensor, a pressure sensor, an air flow monitor, a gas detector, a proximity sensor, a magnetic reed switch, and a temperature sensor. Parameters that can be measured by a sensor of a sensor device 660 can include, but are not limited to, presence of a laser, movement, a magnetic field, and infrared light. A sensor device 660 can be dedicated to the test interface 665 and/or can be used for non-testing purposes. The parameters measured by the sensors of the sensor devices 660 can be used by the controller 604 of the internal lighting module 650. Such measurements can be used to test the functionality of the emergency power source 690, the emergency power supply 691 (discussed below), and/or the light sources 654 of the internal lighting module 650. In addition, or in the alternative, such measurements can be used by the controller 504 and/or for a device or system outside of the recessed luminaire 500.

As discussed above, in some cases, the internal lighting module 650 can include one or more sensor devices 660 that are not part of the test interface 665. In such a case, those one or more sensor devices 660 can measure one or more parameters that the controller 604 can use to operate other non-testing aspects of the internal lighting module 650. For example, a sensor device 660 can measure temperature, and the controller can use these temperature measurements to determine if the internal lighting module 650 is overheating.

The controller 604 of the internal lighting module 650 can be configured to communicate with (and in some cases control) the sensor devices 660. Alternatively, the controller 504 of the recessed luminaire 500 (shown being disposed in the enclosure 501) can be configured to communicate with (and in some cases control) the sensor devices 660. Each sensor device 660 can use one or more of a number of communication protocols for sending and receiving communication signals. To the extent that a sensor device 660 needs power to operate, the sensor device 660 can be powered by the emergency power supply 691. Alternatively, such a sensor device 660 can include a battery or other type of energy storage device.

The light sources 654 of the internal lighting module 650 that provide general illumination. In this particular case, the light sources 654 provide light for a path of egress in an emergency situation (e.g., a fire, a loss of primary power). In alternative embodiments, the light sources 654 can provide, additionally or alternatively, other types of light, including but not limited to accent lighting, low-level lighting (as when the light sources 654 are used as a night light, to provide mood lighting, to accompany music being broadcast or a movie being played, as an indicator light (e.g., an indicator of a network connection, an indicator of the occurrence of an event, an indicator of the occurrence of a status, etc.), and/or as a communication light (as when the light sources 654 are used in conjunction with the digital assistant 519). The light sources 654 can emit light using power provided by the emergency power source 690 through the emergency power supply 691. In addition, or in the alternative, such as when the light sources 654 are used for purposes (e.g., night light, accent lighting, mood lighting, indicator of a network connection, activity ring for a digital assistant 519, etc.) in addition to or aside from providing emergency egress lighting, the light sources 654 can emit light using power provided by a primary power source 590 through the primary power supply 591. In such cases, the primary power supply 591 can have multiple output channels, where one output channel supplies power to the components in the enclosure 501, and where another output channel supplies power to the internal lighting module 650.

The internal lighting module 650 can have any number of light sources 654. Each light source 654 can use any type of lighting technology (e.g., light-emitting diode, incandescent, fluorescent, halogen). A light source 654 can vary in the amount and/or color (e.g., white, red, green, blue) of light that it emits. Control of a light source 654 in terms of features such as color, temperature, dimming level, etc. can be provided by the emergency power supply 691, the primary power supply 591, the controller 604, and/or the controller 504.

In certain example embodiments, the emergency power supply 691 of the internal lighting module 650 receives power from the emergency power source 690. The emergency power supply 691 uses the power it receives to generate and provide power (also called emergency power herein) to one or more other components (e.g., the light sources 654, the controller 604, the test interface 665 (including a sensor device 660)) of the internal lighting module 650. The emergency power supply 691 can be called by any of a number of other names, including but not limited to a driver, a LED driver, and a ballast. The emergency power supply 691 can include one or more of a number of single or multiple discrete components (e.g., transistor, diode, resistor), and/or a microprocessor. The emergency power supply 691 may include a printed circuit board, upon which the microprocessor and/or one or more discrete components are positioned.

In some cases, the emergency power supply 691 can include one or more components (e.g., a transformer, a diode bridge, an inverter, a converter) that receives power from the emergency power source 690 and generates power of a type (e.g., alternating current, direct current) and level (e.g., 12V, 24V, 120V) that can be used by one or more other components (e.g., light sources 654, the controller 604, the test interface 665 (including a sensor device 660)) of the internal lighting module 650. In addition, or in the alternative, the emergency power supply 691 can be or include a source of power in itself. For example, the emergency power supply 691 can be or include a battery, a localized photovoltaic solar power system, or some other source of independent power.

The controller 604 of the internal lighting module 650 can include one or more of a number of components. As shown in FIG. 6, such components can include, but are not limited to, a control engine 606, a communication module 608, a timer 610, a power module 612, a storage repository 630, a hardware processor 620, a memory 622, a transceiver 624, an application interface 626, and, optionally, a security module 628. The controller 604 (or components thereof) can be located within the cavity 662 and/or on the housing 651 of the internal lighting module 650. In some cases, the controller 604 (or components thereof) can be located remotely from the internal lighting module 650.

The storage repository 630 of the controller 604 can be a persistent storage device (or set of devices) that stores software and data used to assist the controller 604 in communicating with one or more other components (e.g., the one or more users 592 (including associated user systems 594), the primary power source 590, the emergency power source 690, the network manager 580, the test interface 665 (including one or more of the sensor devices 660), a sensor device 660 used for non-testing purposes, the emergency power supply 691) of the system 599. In one or more example embodiments, the storage repository 630 stores one or more protocols 632, algorithms 633, and stored data 634. The protocols 632 of the storage repository 630 can be any procedures (e.g., a series of method steps) and/or other similar operational procedures that the control engine 606 of the controller 604 follows based on certain conditions at a point in time.

The protocols 632 can include any of a number of communication protocols that are used to send and/or receive data between the controller 604 and one or more other components of the system 599. Such protocols 632 used for communication can be a time-synchronized protocol. Examples of such time-synchronized protocols can include, but are not limited to, a highway addressable remote transducer (HART) protocol, a wirelessHART protocol, and an International Society of Automation (ISA) 100 protocol. In this way, one or more of the protocols 632 can provide a layer of security to the data transferred within the system 599. Other protocols 632 used for communication can be associated with the use of laser transmission, Wi-Fi, Zigbee, VLC, cellular networking, BLE, UWB, and Bluetooth.

The algorithms 633 can be any formulas, mathematical models, forecasts, simulations, and/or other similar tools that the control engine 606 of the controller 604 uses to reach a computational conclusion. For example, one or more algorithms 633 can be used to determine how much time the various components of the internal lighting module 650 can operate before the emergency power source 690 is depleted of emergency power. As another example, one or more algorithms 633 can be used to determine various characteristics (e.g., angle of arrival) associated with a signal received by a sensor device 660 or the transceiver 624.

Stored data 634 can be any data associated with any components of the system 599, threshold values, tables, results of previously run or calculated algorithms 633, updates to protocols 632, user preferences, and/or any other suitable data. Such data can be any type of data, including but not limited to historical data, present data, and future data (e.g., forecasts). The stored data 634 can be associated with some measurement of time derived, for example, from the timer 610.

Examples of a storage repository 630 can include, but are not limited to, a database (or a number of databases), a file system, cloud-based storage, a hard drive, flash memory, some other form of solid-state data storage, or any suitable combination thereof. The storage repository 630 can be located on multiple physical machines, each storing all or a portion of the protocols 632, the algorithms 633, and/or the stored data 634 according to some example embodiments. Each storage unit or device can be physically located in the same or in a different geographic location. The storage repository 630 can be operatively connected to the control engine 606. In one or more example embodiments, the control engine 606 includes functionality to communicate with other components in the system 599. More specifically, the control engine 606 sends information to and/or receives information from the storage repository 630 in order to communicate with one or more other components in the system 599.

In certain example embodiments, the control engine 606 of the controller 604 controls the operation of one or more components (e.g., the communication module 608, the timer 610, the transceiver 624) of the controller 604. For example, the control engine 606 can activate the communication module 608 when the communication module 608 is in “sleep” mode and when the communication module 608 is needed to send data to another component (e.g., the emergency power supply 691) in the system 599. The control engine 606 can also communicate with and/or control another component of the internal lighting module 650. For example, the control engine 606 can control the test interface 665 (including one or more of the sensor devices 660) and/or other sensor devices 660 used for non-testing purposes. In some cases, the control engine 606 can also communicate with, send instructions to, and/or receive instructions from the controller 504. The control engine 606 can use one or more protocols 632 to facilitate communication with the other components in the system 599.

The control engine 606, using one or more protocols 632 and/or one or more algorithms 633, can facilitate the illumination of the light sources 654, either when during a test (e.g., triggered by activation of the test interface 665, triggered by a sensor device 660 of the test interface 665 detecting a laser initiated by a user 592), when the primary power source 590 is unavailable, or during some other time or event. In some cases, the control engine 606, using one or more protocols 632 and/or one or more algorithms 633, can facilitate the illumination of the light sources 654 to act as a night light, an accent light (e.g., to provide indirect lighting), to provide mood lighting, to accompany music being broadcast or a movie being played, as an indicator light (e.g., to indicate a network connection, to indicate the occurrence of an event, to indicate a status, etc.), and/or as a communication light (e.g., when used in conjunction with the digital assistant 519).

In some cases, the control engine 606, using one or more protocols 632 and/or one or more algorithms 633, can control one or more characteristics (e.g., color output (e.g., white, green, red, blue), temperature output, dimming level) of the light emitted by one or more of the light sources 654. In some cases, the control engine 606, using one or more protocols 632 and/or one or more algorithms 633, can control the light sources 654 to serve as an activity ring for the digital assistant 519. For some of these alternative functions (e.g., use of the light sources 654 as a night light, use of the light sources 654 as an activity ring for the digital assistant 519, use of the light sources 654 to indicate a network connection, use of the light sources 654 to emit decorative colors, use of the light sources 654 for mood lighting, and/or use of the light sources 654 to accompany music being broadcast or a movie being played), the light sources 654 can receive power from the primary power supply 591, from the primary power source 590, or from some other source of power aside from the emergency power source 690.

In certain example embodiments, the control engine 606 can include an interface that enables the control engine 606 to communicate with one or more of the other components of the system 599. For example, if the internal lighting module 650 operates under IEC Standard 62386, then the internal lighting module 650 can have a serial communication interface that will transfer data with a user system 594 or the network manager 580. In such a case, the control engine 606 can also include a serial interface to enable communication with the user system 594 or the network manager 580. Such an interface can operate in conjunction with, or independently of, the protocols 632 used to communicate between the controller 604 and the other components of the system 599.

The control engine 606 (or other components of the controller 604) can also include one or more hardware components and/or software elements to perform its functions. Such components can include, but are not limited to, a universal asynchronous receiver/transmitter (UART), a serial peripheral interface (SPI), a direct-attached capacity (DAC) storage device, an analog-to-digital converter, an inter-integrated circuit (I2C), and a pulse width modulator (PWM).

The communication module 608 of the controller 604 determines and implements the communication protocol (e.g., from the protocols 632 of the storage repository 630) that is used when the control engine 606 communicates with (e.g., sends signals to, receives signals from) the other components of the system 599. In some cases, the communication module 608 accesses the stored data 634 to determine which communication protocol is used to communicate with another component of the system 599. In addition, the communication module 608 can identify and/or interpret the communication protocol of a communication received by the controller 604 so that the control engine 606 can interpret the communication. The communication module 608 can also provide one or more of a number of other services with respect to data sent from and received by the controller 604. Such services can include, but are not limited to, data packet routing information and procedures to follow in the event of data interruption.

The timer 610 of the controller 604 can track clock time, intervals of time, an amount of time, and/or any other measure of time. The timer 610 can also count the number of occurrences of an event, whether with or without respect to time. Alternatively, the control engine 606 can perform the counting function. The timer 610 is able to track multiple time measurements concurrently. The timer 610 can track time periods based on an instruction received from the control engine 606, based on an instruction received from a user 592, based on an instruction programmed in the software for the controller 604, based on some other condition or from some other component, or from any combination thereof. In certain example embodiments, the timer 610 can provide a time stamp for each packet of data received from another component of the system 599.

The power module 612 of the controller 604 receives power from a power supply (e.g., the emergency power supply 691, the primary power supply 591) and manipulates (e.g., transforms, rectifies, inverts) that power to provide the manipulated power to one or more other components (e.g., the timer 610, the control engine 606) of the controller 604, where the manipulated power is of a type (e.g., alternating current, direct current) and level (e.g., 12V, 24V, 120V) that can be used by the other components of the controller 604. The power module 612 can include one or more of a number of single or multiple discrete components (e.g., transistor, diode, resistor, transformer), and/or a microprocessor. The power module 612 may include a printed circuit board, upon which the microprocessor and/or one or more discrete components are positioned.

In some cases, the power module 612 can include one or more components that allow the power module 612 to measure one or more elements of power (e.g., voltage, current) that is delivered to and/or sent from the power module 612. In addition, or in the alternative, the power module 612 can be a source of power in itself to provide signals to the other components of the controller 604. For example, the power module 612 can be or include an energy storage device (e.g., a battery). As another example, the power module 612 can be or include a localized photovoltaic power system.

The hardware processor 620 of the controller 604 executes software, algorithms, and firmware in accordance with one or more example embodiments. Specifically, the hardware processor 620 can execute software on the control engine 606 or any other portion of the controller 604, as well as software used by one or more of the other components of the system 599. The hardware processor 620 can be an integrated circuit, a central processing unit, a multi-core processing chip, SoC, a multi-chip module including multiple multi-core processing chips, or other hardware processor in one or more example embodiments. The hardware processor 620 can be known by other names, including but not limited to a computer processor, a microprocessor, and a multi-core processor.

In one or more example embodiments, the hardware processor 620 executes software instructions stored in memory 622. The memory 622 includes one or more cache memories, main memory, and/or any other suitable type of memory. The memory 622 can include volatile and/or non-volatile memory. The memory 622 is discretely located within the controller 604 relative to the hardware processor 620 according to some example embodiments. In certain configurations, the memory 622 can be integrated with the hardware processor 620.

In certain example embodiments, the controller 604 does not include a hardware processor 620. In such a case, the controller 604 can include, as an example, one or more field programmable gate arrays (FPGA), one or more insulated-gate bipolar transistors (IGBTs), one or more integrated circuits (ICs). Using FPGAs, IGBTs, ICs, and/or other similar devices known in the art allows the controller 604 (or portions thereof) to be programmable and function according to certain logic rules and thresholds without the use of a hardware processor 620. Alternatively, FPGAs, IGBTs, ICs, and/or similar devices can be used in conjunction with one or more hardware processors 620.

The transceiver 624 of the controller 604 can send and/or receive control and/or communication signals. Specifically, the transceiver 624 can be used to transfer data between the controller 604 and the other components of the system 599. The transceiver 624 can use wired and/or wireless technology. The transceiver 624 can be configured in such a way that the control and/or communication signals sent and/or received by the transceiver 624 can be received and/or sent by another transceiver that is part of one or more other components of the system 599. The transceiver 624 can send and/or receive any of a number of signal types, including but not limited to radio frequency signals. When the transceiver 624 uses wireless technology, any type of wireless technology can be used by the transceiver 624 in sending and receiving signals. Such wireless technology can include, but is not limited to, Wi-Fi, Zigbee, VLC, cellular networking, BLE, UWB, and Bluetooth. The transceiver 624 can use one or more of any number of suitable communication protocols (e.g., ISA100, HART) when sending and/or receiving signals.

Optionally, in one or more example embodiments, the security module 628 secures interactions between the controller 604 and the other components of the system 599. More specifically, the security module 628 authenticates communication from software based on security keys verifying the identity of the source of the communication. For example, user software may be associated with a security key enabling the software of a user system 594 to interact with the controller 604. Further, the security module 628 can restrict receipt of information, requests for information, and/or access to information.

One or more of the other components of the system 599 can interact with the controller 604 using the application interface 626 in accordance with one or more example embodiments. Specifically, the application interface 626 of the controller 604 receives data (e.g., information, communications, instructions, updates to firmware) from and sends data (e.g., information, communications, instructions) to one or more of the other components of the system 599. Examples of an application interface 626 can be or include, but are not limited to, an application programming interface, a keyboard, a web service, a data protocol adapter, some other hardware and/or software, or any suitable combination thereof. Similarly, the other components of the system 599 can include an interface (similar to the application interface 626 of the controller 604) to receive data from and send data to the controller 604 in certain example embodiments.

In addition, any of the components (e.g., a user system 594 of a user 592, the digital assistant 519) can include a user interface. Examples of such a user interface can include, but are not limited to, a graphical user interface, a touchscreen, a keyboard, a monitor, a mouse, some other hardware, or any suitable combination thereof. The controller 604 and the other components of the system 599 can use their own system or share a system in certain example embodiments. Such a system can be, or contain a form of, an Internet-based or an intranet-based computer system that is capable of communicating with various software. A computer system includes any type of computing device and/or communication device, including but not limited to the controller 604. Examples of such a system can include, but are not limited to, a desktop computer with a Local Area Network (LAN), a Wide Area Network (WAN), Internet or intranet access, a laptop computer with LAN, WAN, Internet or intranet access, a smart phone, a server, a server farm, an android device (or equivalent), a tablet, smartphones, and a personal digital assistant (PDA). Such a system can correspond to a computer system as described below with regard to FIG. 7.

Further, as discussed above, such a system can have corresponding software (e.g., user system software, sensor device software, controller software, network manager software). The software can execute on the same or a separate device (e.g., a server, mainframe, desktop personal computer (PC), laptop, PDA, television, cable box, satellite box, kiosk, telephone, mobile phone, or other computing devices) and can be coupled by the communication network (e.g., Internet, Intranet, Extranet, LAN, WAN, or other network communication methods) and/or communication channels, with wire and/or wireless segments according to some example embodiments. The software of one system can be a part of, or operate separately but in conjunction with, the software of another system within the system 599.

The enclosure 501 of the recessed luminaire 500 can have a cavity 509 inside of which one or more components of the recessed luminaire 500 can be disposed. For example, in this case, the cavity 509 of the enclosure 501 can have disposed therein one or more light sources 554, a primary power supply 591, an optional controller 504, and one or more optional sensor devices 560. In some cases, one or more of these components are located on the enclosure 501 or remotely from the enclosure 501 rather than inside the cavity 509 of the enclosure 501. The enclosure 501 has a bottom end 507, substantially similar to the bottom end 107 of the enclosure 101, that is engaged by the one or more securing member assemblies 525.

The light sources 554 can be substantially similar to the light sources 654 of the internal lighting module 650, except that the light sources 554 are configured to provide general illumination when the primary power source 590 is available. The primary power supply 591 can be substantially similar to the emergency power supply 691 of the internal lighting module 650, except that the primary power supply 591 can, in some optional embodiments using power transfer links 587, provide power to the light sources 654 of the internal lighting module 650 in addition to the light sources 554 during times when the light sources 654 are used for such alternative functions as performing as a night light, performing as an activity ring for the digital assistant 519, performing as an indicator of a network connection, to accompany music or a movie being broadcast, to provide mood lighting, and/or emitting decorative colors, etc.

The sensor devices 560 can be substantially similar to the sensor devices 660 of the internal lighting module 650, except that the sensor devices 560 can have more of a focus on measuring parameters that affect operation of the recessed luminaire 500 for the purpose of providing general illumination. The controller 504 can be substantially similar, in terms of components and/or functionality, to the controller 604 of the internal lighting module 650. In alternative embodiments, the controller 504 can communicate with, be controlled by, and/or control the controller 604 using optional communication links 505.

FIG. 7 illustrates one embodiment of a computing device 718 that implements one or more of the various techniques described herein, and which is representative, in whole or in part, of the elements described herein pursuant to certain example embodiments. For example, the controller 604 of the internal lighting module 650 (including components thereof, such as the control engine 606, the hardware processor 620, the storage repository 630, and the transceiver 624) can be considered a computing device 718. Computing device 718 is one example of a computing device and is not intended to suggest any limitation as to scope of use or functionality of the computing device and/or its possible architectures. Neither should the computing device 718 be interpreted as having any dependency or requirement relating to any one or combination of components illustrated in the example computing device 718.

The computing device 718 includes one or more processors or processing units 714, one or more memory/storage components 715, one or more input/output (I/O) devices 716, and a bus 717 that allows the various components and devices to communicate with one another. The bus 717 represents one or more of any of several types of bus structures, including a memory bus or memory controller, a peripheral bus, an accelerated graphics port, and a processor or local bus using any of a variety of bus architectures. The bus 717 includes wired and/or wireless buses.

The memory/storage component 715 represents one or more computer storage media. The memory/storage component 715 includes volatile media (such as random access memory (RAM)) and/or nonvolatile media (such as read only memory (ROM), flash memory, optical disks, magnetic disks, and so forth). The memory/storage component 715 includes fixed media (e.g., RAM, ROM, a fixed hard drive, etc.) as well as removable media (e.g., a Flash memory drive, a removable hard drive, an optical disk, and so forth).

One or more I/O devices 716 allow a user to enter commands and information to the computing device 718, and also allow information to be presented to the user and/or other components or devices. Examples of input devices 716 include, but are not limited to, a keyboard, a cursor control device (e.g., a mouse), a microphone, a touchscreen, and a scanner. Examples of output devices include, but are not limited to, a display device (e.g., a monitor or projector), speakers, outputs to a lighting network (e.g., DMX card), a printer, and a network card.

Various techniques are described herein in the general context of software or program modules. Generally, software includes routines, programs, objects, components, data structures, and so forth that perform particular tasks or implement particular abstract data types. An implementation of these modules and techniques are stored on or transmitted across some form of computer readable media. Computer readable media is any available non-transitory medium or non-transitory media that is accessible by a computing device. By way of example, and not limitation, computer readable media includes “computer storage media”.

“Computer storage media” and “computer readable medium” include volatile and non-volatile, removable and non-removable media implemented in any method or technology for storage of information such as computer readable instructions, data structures, program modules, or other data. Computer storage media include, but are not limited to, computer recordable media such as RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which is used to store the desired information, and which is accessible by a computer.

The computer device 718 is connected to a network (not shown) (e.g., a LAN, a WAN such as the Internet, cloud, or any other similar type of network) via a network interface connection (not shown) according to some example embodiments. Those skilled in the art will appreciate that many different types of computer systems exist (e.g., desktop computer, a laptop computer, a personal media device, a mobile device, such as a cell phone or personal digital assistant, or any other computing system capable of executing computer readable instructions), and the aforementioned input and output means take other forms, now known or later developed, in other example embodiments. Generally speaking, the computer system 718 includes at least the minimal processing, input, and/or output means necessary to practice one or more embodiments.

Further, those skilled in the art will appreciate that one or more elements of the aforementioned computer device 718 is located at a remote location and connected to the other elements over a network in certain example embodiments. Further, one or more embodiments is implemented on a distributed system having one or more nodes, where each portion of the implementation is located on a different node within the distributed system. In one or more embodiments, the node corresponds to a computer system. Alternatively, the node corresponds to a processor with associated physical memory in some example embodiments. The node alternatively corresponds to a processor with shared memory and/or resources in some example embodiments.

Example embodiments can be used to allow for an integrated luminaire that includes a module that provides reliable emergency egress lighting without interfering with the primary purpose of the luminaire to provide general illumination. Example embodiments can also provide easy and unobtrusive manual testing (e.g., using a laser, using physical interaction by a user) of the lighting module. Example embodiments can also be used for additional or alternative functions, such as performing as a night light, performing as an activity ring for a digital assistant, performing as an indicator of a network connection, to accompany music or a movie being broadcast, to provide mood lighting, and/or emitting decorative colors, etc. Example embodiments can be used with different types of luminaires, including recessed luminaires. Example embodiments can be used in new installations of luminaires as well as retrofitting existing luminaires. Example embodiments also provide a number of other benefits. Such other benefits can include, but are not limited to, increased ease of maintenance, greater ease of use, improved reliability, flexible features, and compliance with industry standards that apply to luminaires.

Although embodiments described herein are made with reference to example embodiments, it should be appreciated by those skilled in the art that various modifications are well within the scope and spirit of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

1. A luminaire comprising:
an enclosure having a profile shape at its bottom end;
a trim comprising a trim body, wherein the trim body has substantially the profile shape at its top end and wherein the trim body extends from the bottom of the enclosure and forms an aperture for a first light source;
an internal lighting module disposed between the top end of the trim and the bottom end of the enclosure, wherein the internal light module is fully recessed above the ceiling when the luminaire is installed in a ceiling and located above the trim body and below the enclosure, wherein the internal lighting module comprises:
a housing having substantially the profile shape at its top and bottom surfaces,
a second light source, wherein the second light source serves as an indicator light viewable from below the ceiling,
a test interface, wherein the test interface includes a physical interface or a sensor device, and
an electrical connection interface electrically coupled to the second light source; and
a plurality of securing member assemblies that engage at least the bottom end of the enclosure to retain the internal lighting module between the enclosure and the trim.

2. The luminaire of claim 1, wherein the enclosure, the first light source, the internal lighting module, and a portion of the trim are disposed in a plenum.

3. The luminaire of claim 1, wherein the profile shape comprises a circle.

4. The luminaire of claim 1, wherein the housing of the internal lighting module has a height of less than one-half of an inch.

5. The luminaire of claim 1, wherein the second light source functions as a night light.

6. The luminaire of claim 1, wherein the internal lighting module is configured to emit red, green, blue, or white light at different points in time.

7. The luminaire of claim 1, wherein the second light source further functions as an activity ring for a digital assistant.

8. The luminaire of claim 1, wherein the test interface, when engaged, also enables a test of the second light source.

9. The luminaire of claim 1, further comprising: a light guide disposed adjacent to the second light source and within a cavity formed by the housing.

10. The luminaire of claim 1, wherein the sensor device is configured to detect a wireless signal.

11. The luminaire of claim 1, the sensor device, wherein the sensor device engages upon detecting a magnetic field having a minimum strength.

12. The luminaire of claim 1, wherein the electrical connection interface comprises an electrical connector configured to electrically couple to an emergency power source.

13. The luminaire of claim 1, wherein the electrical connection interface comprises a plurality of electrical conductors that are configured to electrically couple to an emergency power source.

14. The luminaire of claim 1, wherein the sensor device detects a wireless signal, and in response to detecting a wireless signal, enables a test of an emergency power source.

15. The luminaire of claim 1, wherein the physical interface includes a pushbutton.
